(19) United States
(12) Patent Application Publication
(10) Pub. No.: US 2008/0301006 A1
(43) Pub. Date: Dec. 4, 2008

(54) Price Comparison For Travel Or Accommodations

(75) Inventors: Nina Holly, Palo Alto, CA (US); James Testa, Palo Alto, CA (US)

Correspondence Address: AERENDE, INC., PMB 518, 555 BRYANT ST., PALO ALTO, CA, 94301, US

(73) Assignee: WEBSITES BY JOVE, LLC, Palo Alto, CA (US)

(21) Appl. No.: 12/186,207

(22) Filed: Aug. 5, 2008

(51) Int. Cl. G06Q 30/00; G06Q 50/00

(52) U.S. Cl. 705/27

(57) ABSTRACT

Inter alia, methods, and means for price comparisons for travel and accommodations. One embodiment identifies an online database where users input the actual prices paid for travel services and accommodations, including any discounts, coupons, or price premiums. The database can be searched by all uses who have subscribed to the service. In one embodiment, the search criteria can any combination of vendor name, travel dates, start and end locations, booking date, flight number, etc. The users can thus determine the prices actually paid by other users for a given travel service or accommodation. This information could be valuable in negotiation better prices from vendors, or in determining if there are better times to make travel bookings.

### CROSS-REFERENCE TO RELATED APPLICATIONS

Patent Application: US 20070299829—Price Comparison engine and related searching methods and systems including merchant bidding
U.S. Pat. No. 7,198,192—Wireless mobile instant product price comparison and product review
U.S. Pat. No. 6,976,006—Method and apparatus for presenting price comparison to prospective buyers

### TECHNICAL FIELD

One embodiment of the invention especially relates to websites that provide price comparisons; and more particularly, one embodiment relates to websites that provide price comparisons based on user supplied data. One embodiment relates to websites that collect users' travel information regarding the transportation and accommodations, and provide users with searchable access to the pricing of all of the other users' travel and accommodations.

### BACKGROUND

To serve Internet shoppers researching prices on the Internet, many services exist for comparing prices of an item or service offered by several merchants. However, a major limitation of such price comparison services is that only the official prices posted by merchants are used in price comparison. Many customers pay less than the listed prices due to a) applicable discounts, b) fluctuating prices, and c) special offers. Conversely, in situations where an item is in high customer demand and therefore scarce, shoppers may actually pay more than the list price. In either case, the actual price of an item is typically not publicly available, and is known only by the merchant and the purchaser. A more accurate price comparison would be based upon the amount that customers have actually paid for the item or service.

One example of “Price Comparisons for Travel and Accommodations” is an online price comparison service listing prices for transportation and accommodations. The users input the prices they have paid for travel services (e.g.: airline tickets, hotel accommodations, etc.), and they can also search over the entire database to find out what other users are paying for the same transportation and accommodations.

Allowing the user to search the database with respect to specific criteria allows the user to find transportation and accommodations which would fit the user's interests, and would enable the user to negotiate for better rates with travel vendors. Possible search criteria could include:

a) Vendor

b) Conveyance type (e.g.: flight, train, boat, car)

c) Conveyance class (e.g. first, business, coach)

d) Start city/airport and end city/airport

e) Start date and end date

f) Flight number

### BACKGROUND OF INVENTION

### Prior Art

Searching for the list prices of items on the Internet is not a new phenomenon. For example, consider the patent application by Alan Boinus, “Price comparison engine and related searching methods and systems including merchant bidding”, US Patent Application 20070299829 filed Dec. 27, 2007. This patent application describes a price search engine that searches the Internet for listed prices of queried items. The limitation of this type of search engine is that it does not have access to the prices that the customers actually paid for the queried items. The prices that the customers actually paid could have been less than the prices found on the Internet via a queried search because of discounts, coupons, travel packages, cookies on the customer's web browser and the time the item was purchased.

Another known approach is described in Steven L. Page, et al, “Wireless mobile instant product price comparison and product review”, U.S. Pat. No. 7,198,192. This patent describes how a user can input the information in an RFID tag into a mobile device which then queries a server to determine the price of the item that had the RFID tag attached to it. The limitation of this patent, similar to the previous patent, is that it does not describe a method for determining what other customers actually paid for the price of the item.

Another known approach is described in Chhedi Lal Verma, et al, “Method and apparatus for presenting price comparison to prospective buyers” U.S. Pat. No. 6,976,006. This patent describes searching the Internet to collect product data, including prices, stored in a database and organized so that the customer can search for the lowest advertised price. The limitation of this patent is that it does not describe a method for determining what other buyers actually paid for the price of the item.

Another known approach is described in Marc Alan Ehrlich, “System, method and computer program product for on-line, real-time price comparison and adjustment within a detachable virtual shopping cart”, U.S. Pat. No. 6,873,968. This patent describes searching the Internet for the lowest possible price, but also allowing a merchant to lower the item price extended to a customer if the customer adds to his shopping cart a given item with a lower price than the first merchant offers. The limitation of this patent is that it does not describe a method for determining what customers actually paid for an item.

### OBJECTS AND ADVANTAGES

The Price Comparisons for Travel or Accommodations has the following main advantages:
1) the user can determine the actual price that other users paid for travel and accommodations, including any coupons, discounts, or price premiums,
2) the user can determine the discount or premium rate that other users paid for a specific travel service or accommodation relative to the list price of such services or accommodations,
3) the user can determine when other users' travel or accommodations were booked to see if the same travel or accommodation booked on other days resulted in a different price,
4) the user can search on the search criteria in a fuzzy manner such that the search results can differ from the search criteria by some pre-determined hamming distance. For example, someone searching for “SFI” would match on “SFO” if the hamming distance search value was set to allow one character to differ between the search criteria and the search results.

### SUMMARY

Inter alia, methods, and means for online shoppers to determine the actual price paid by other buyers for a product or service. One embodiment identifies an online database where users input the actual prices paid for travel services and accommodations, including any discounts, coupons, or price premiums. All users registered with the database can search the database by various criteria, such as vendor name, travel dates, start and end locations, booking date, etc. The users can thus determine the prices paid by other users for a given travel service or accommodation, use the information to negotiate for better prices with the vendors, and know whether a vendor is offering a favorable price.

### BRIEF DESCRIPTION OF THE DRAWINGS

The appended claims set forth the features of price comparisons for travel and accommodations with particularity. The price comparisons for travel and accommodations, together with its advantages, may be best understood from the following detailed description taken in conjunction with the accompanying drawings of which:

FIG. 1 illustrates the databases used in price comparisons for travel and accommodations. The accommodations database can be searched to provide an accommodations ID that can be input into the accommodations_vendor database which provides the vendor entry in the vendor database which outputs a vendor name. This vendor name can be compared to the vendor input to see if this accommodation is for that vendor. If the vendor name matches, the price and specific information from that accommodation is output as part of the search results. Further any of the following search criteria can be used to select an entry in the accommodations database: 1) conveyance, 2) start and end Location, 3) flight number, 4) start and end date.

FIG. 2. illustrates the web page used to search through other users' stored information on the prices that they paid for their travel and accommodations. Step 1, which is required, consists of selecting a 1) vendor or a 2) conveyance. Step 2, which is optional, consists of selecting: 1) start and end location, and/or 2) a start and end date, and/or 3) a flight number. Step 3, which is required consists of selecting an exact search or a fuzzy search (which is a search that returns items that aren't a direct match. The search results that are returned contain the following information: a) vendor, b) conveyance, c) flight number, d) start date and start time, e) end date and end time, f) start location, g) end location, h) conveyance class, i) discount rate, j) date booked, k) price.

### DETAILED DESCRIPTION

Inter alia, methods, means and apparatus are disclosed for a searchable database containing information about travel services and accommodations, including vendors, start and end locations, conveyance numbers, prices paid by other travelers, etc.

Embodiments described herein include various elements and limitations, with no one element or limitation contemplated as being a critical element or limitation. Each of the claims individually recites an aspect of the price comparison for travel or accommodations in its entirety. Moreover, some embodiments described may include, but are not limited to, inter alia, systems, networks, integrated circuit chips, embedded processors, ASICs, methods and computer-readable medium containing instructions. The embodiments described hereinafter embody various aspects and configurations within the scope and spirit of the price comparison for travel or accommodations, with the Figs illustrating exemplary and non-limiting configurations.

The term “system” is used generally herein to describe any number of components, elements, systems, devices, packet switch elements, packet switches, routers, networks, computer and/or communication devices or mechanisms, or combinations of components thereof. The term “computer” is used generically herein to describe any number of computers, including, but not limited to personal computers, embedded processing elements and systems, control logic, ASICs, chips, workstations, mainframes, etc. The term “processing element” is used generically herein to describe any type of processing mechanism or devices, such as a processor, ASIC, field programmable gate array, computer, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the Figs, including, but not limited to any block and flow diagrams and message sequence charts, may be performed in the same or in a different serial or parallel ordering and/or by different components and/or processes, threads, etc., and/or over different connections and be combined with other functions in other embodiments in keeping within the scope and spirit of the price comparisons for travel or accommodations. Furthermore, the term “identify” is used generically to describe any manner or mechanism for directly or indirectly ascertaining something, which may include but is not limited to receiving, retrieving ROM memory, determining, defining, calculating, generating, etc.

Moreover, the terms “network” and “communications mechanism” are used generically herein to describe one or more networks, communications mediums or communications systems, including, but not limited to the Internet, private or public telephone, cellular, wireless, satellite, cable, local area, metropolitan area and/or wide area networks, a cable electrical connection, bus, etc., and internal communications mechanisms such as message passing, inter-process communications, shared memory, etc. The term “message” is used generically herein to describe a piece of information which may or may not be, but is typically communicated via one or more communication mechanisms of any type.

The term “storage mechanism” includes any type of memory, storage device or other mechanism for maintaining instructions or data in any format. “Computer readable medium” is an extensible term including any memory, storage device, storage mechanism, and other storage and signaling mechanisms including interfaces and devices such as network interface cards and buffers therein, a well as any communications devices and signals received and transmitted, and other current and evolving technologies that a computerized system can interpret, receive, and/or transmit. The term “memory” includes any random access memory (RAM), read only memory (ROM), flash memory, integrated circuits, and/or other memory components or elements. The term “storage device” includes any solid state storage media, disk drivers, diskettes, networked services, tape drives, and other storage devices. Memories and storage devices may store computer-executable instructions to be executed by a processing element and/or control logic, and data which is manipulated by a processing element and/or control logic. The term “data structure” is an extensible term referring to any data element, variable, data structure, database, and/or one or more organizational schemes that can be applied to data to facilitate interpreting the data or performing operations on it, such as, but not limited to memory locations or devices, sets, queues, trees, heaps, lists, linked lists, arrays, tables, pointers, etc. A data structure is typically maintained in a storage mechanism. The terms “pointer” and “link” are used generically herein to identify some mechanism for referencing or identifying another element, component, or other entity, and these may include, but are not limited to a reference to a memory or other storage mechanism or location therein, an index in a data structure, a value, etc. The term “associate memory” is an extensible term, and refers to all types of known or future developed associative memories, including, but not limited to binary and ternary content addressable memories, hash tables, TRIE and other data structures, etc. Additionally, the term “associative memory unit” may include, but it not limited to one or more associative memory devices or parts thereof, including, but not limited to regions, segments, banks, pages, blocks, sets of entries, etc.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the phrase “means for xxx” typically includes computer-readable medium containing computer-executable instructions for performing xxx.

In addition, the terms “first”, “second”, etc. are typically used herein to denote different units (e.g., a first element, a second element). The use of these terms herein does not necessarily connote an ordering such as one unit or event occurring or coming before another, but rather provides a mechanism to distinguish between particular units. Additionally, the use of the singular tense of a noun is non-limiting, with its use typically including one or more of the particular thing rather than just one (e.g., the use of the word “memory” typically refers to one or more memories without having to specify “memory or memories” or “one or more memories” or “at least one memory”, etc.). Moreover, the phrases “based on x” and “in response to x” are used to indicate a minimum set of items x from which something is derived or caused, wherein “x” is extensible and does not necessarily describe a complete list of items on which the operations is performed, etc. Additionally, the phrase “coupled to” is used to indicate some level of direct or indirect connections between two elements or devices, with the coupling device or devices modifying or not modifying the coupled signal or communicated information. The term “subset” is used to indicate a group of all or less than all of the elements of a set. The term “or” is used herein to identify a selection of one or more, including all, of the conjunctive items.

### PREFERRED EMBODIMENT

A method of price comparison for travel and accommodations is of particular use in allowing a user to determine the actual prices, including discounts or price premiums, that others have paid for travel services or accommodations.

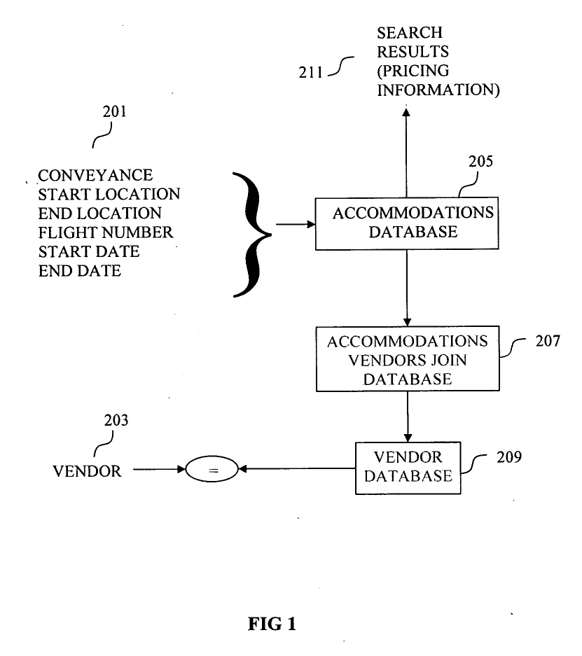

One embodiment that allows a user to determine the actual prices paid by others for travel or accommodations consists of a website where other users can store their travel/accommodation information, including the prices they have paid for the travel services or accommodations. One embodiment allows users to send confirmation emails received from vendors to the website. The website extracts the particulars of the travel services or accommodations, including the price data, from the confirmation emails and stores them in a searchable database. FIG. 1 illustrates the databases used to store the travel accommodations, 205, and the vendor database, 209.

One embodiment receives the user's search criteria and extracts any HTML, Javascript or SQL commands from the user's search criteria, to prohibit the user from manipulating the database by performing SQL-injection or by executing commands using Javascript. The resulting user input can be used as search criteria to determine what prices others are paying for travel accommodations and services.

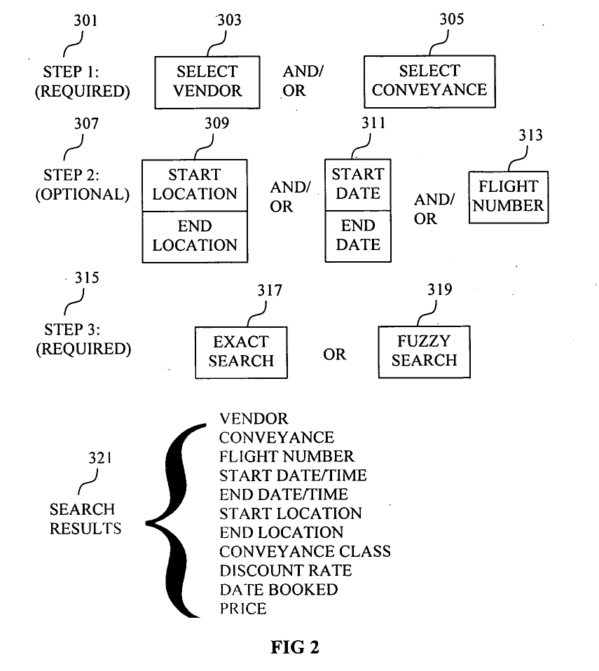

One embodiment allows the user to search for travel/accommodations based on the following single and combined criteria as shown in FIG. 2:
1) Vendor
2) Conveyance (flight, train, car, hotel, boat, walk, other)
3) Vendor and Conveyance
4) Vendor and Conveyance and Flight/Conveyance Number
5) Conveyance and Start Date and End Date
6) Conveyance and Start Location and End Location
7) Vendor and Conveyance and Start Date and End Date
8) Vendor and Conveyance and Start Location and End Location
9) Conveyance and Start Date and End Date and Start Location and End Location
10) Conveyance and Conveyance/Flight Number and Start Date and End Date and Start Location and End Location
11) Vendor and Conveyance and Conveyance/Flight Number and Start Date and End Date and Start Location and End Location

FIG. 1 illustrates the above input fields, 201, input as search criteria into the accommodations database. The accommodations that match the search criteria are output, 211, which provides pricing information as well as the following information:

a) vendor,

b) conveyance,

c) flight number,

d) start date and start time,

e) end date and end time,

f) start location,

g) end location,

h) conveyance class,

i) discount rate,

j) date booked,

k) price.

If vendor is used as one of the inputs, 203, the results output from the accommodations database are further filtered based on which of the accommodations has the same vendor as the input vendor, 203. This is accomplished by taking the accommodation ID from each selected accommodation based on the search criteria 201, and using that accommodation ID as the input into the accommodations_vendors join database, 207, to provide a vendor ID. That vendor ID is input into the vendor database, 209, which outputs a vendor name. If that vendor name matches the input vendor name, 203, then the selected accommodation's fields are output as the search results.

FIG. 2 shows the web page with the input fields that the user uses to initiate a search. Step 1, 301, indicates the required fields, vendor, 303 and/or conveyance, 305. Step 2, 307, indicates an optional step of selecting: 1) start and end location, 309, 2) start and end date, 311, 3) flight number, 313. Step 3, 315, is a required step of selecting either an exact search, 317, or a fuzzy search, 319.

### ALTERNATIVE EMBODIMENTS

Alternative embodiments could consist of searching on different criteria or different arrangements of the existing criteria.

Another embodiment could consist of searching not over travel and accommodations databases, but over:
A) the pricing of business contracts for large quantities of materials, finished goods,
B) the actual prices paid for real estate,
C) the actual prices paid for cars,
D) the actual prices paid for airplanes,

### CONCLUSION, RAMIFICATIONS AND SCOPE

In view of the many possible embodiments to which the principles of the price comparisons for travel or accommodations, may be applied, it will be appreciated that the embodiments and aspects thereof described herein with respect to the drawings/figures are only illustrative and should not be taken as limiting the scope of the price comparisons for travel or accommodations. For example and as would be apparent to one skilled in the art, many different types of data can be searched for, and many different types of search criteria can be applied.

What is claimed is:

1. In combination:
(a) an accommodations database containing travel accommodations, and
(b) a means for searching accommodations database to find accommodations that match the search criteria for the accommodations, to select those accommodations and provide the price the users actually paid for the accommodations.

2. The price comparisons for travel or accommodations means according to claim 1, further including:
(a) a vendor database containing vendors for the travel accommodations, and
(b) an accommodations_vendors database which indicates which accommodations use which vendors, and
(c) a means for searching accommodations database and the vendor database to find accommodations that match the search criteria for the vendor and the search criteria for the accommodations, to select those accommodations and provide the price the users actually paid for the accommodations.

3. The price comparisons for travel or accommodations means according to claim 1, further including a web page that allows any user subscribed to the website to search on criteria such as vendor name, travel dates, start and end locations, booking date, flight number.

4. The price comparisons for travel or accommodations means according to claim 1, further including the ability to search on the search criteria in a fuzzy sense, where the search results do not need to be exact matches on the search criteria but can be some pre-determined hamming distance away from the search criteria.
